(19) United States
(12) Patent Application Publication
(10) Pub. No.: US 2026/0099851 A1
(43) Pub. Date: Apr. 9, 2026

(54) Electronic Devices and Corresponding Methods for Suggesting Potential Recipients for Screenshot Captures of Electronic Payment Transactions

(71) Applicant: Motorola Mobility LLC, Chicago, IL (US)

(72) Inventors: Amit Kumar Agrawal, Bangalore (IN); Krishnan Raghavan, Bangalore (IN)

(21) Appl. No.: 18/908,614

(22) Filed: Oct. 7, 2024

(51) Int. Cl. G06Q 20/42; G06Q 20/32; G06Q 20/38

(52) U.S. Cl. CPC G06Q 20/42; G06Q 20/326; G06Q 20/389

(57) ABSTRACT

An electronic device and corresponding methods facilitate the sharing of screenshots of electronic payment transaction confirmations. The device receives user input completing an electronic payment transaction and presents a confirmation on the user interface. Upon receiving additional user input to transmit a screenshot of the confirmation, the device extracts the transaction recipient from the screenshot. The device correlates the recipient with a contacts list to determine contact information and transmits the screenshot using this information. The system can prioritize potential recipients based on previous transactions and can use artificial intelligence to enhance accuracy. The device can also record transaction details and recipient information for future reference.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. It would be advantageous to have improved electronic devices and corresponding methods and systems to streamline user engagement with such applications.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates a user engaging one explanatory electronic device configured in accordance with one or more embodiments of the disclosure.

FIG. 3 illustrates one explanatory system in accordance with one or more embodiments of the disclosure.

FIG. 4 illustrates one explanatory method in accordance with one or more embodiments of the disclosure.

FIG. 5 illustrates explanatory electronic device in accordance with one or more embodiments of the disclosure.

FIG. 6 illustrates another explanatory electronic device in accordance with one or more embodiments of the disclosure.

FIG. 7 illustrates still another explanatory electronic device in accordance with one or more embodiments of the disclosure.

FIG. 8 illustrates yet another explanatory electronic device in accordance with one or more embodiments of the disclosure.

FIG. 9 illustrates another explanatory electronic device in accordance with one or more embodiments of the disclosure.

FIG. 10 illustrates another explanatory electronic device in accordance with one or more embodiments of the disclosure.

FIG. 11 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, at a user interface, user input completing an electronic payment transaction defining an electronic payment transaction recipient and resulting in presentation of an electronic payment transaction confirmation by the user interface, receiving, at the user interface, other user input requesting a communication device of the electronic device to transmit a screenshot of the electronic payment transaction confirmation to a remote electronic device, extracting, by one or more processors from the screenshot of the electronic payment transaction confirmation, the electronic payment transaction recipient, correlating, by the one or more processors, the electronic payment transaction recipient with a contacts list accessible by the one or more processors to determine contact information for the electronic payment transaction recipient, and causing, by the one or more processors, the communication device to transmit the screenshot of the electronic payment transaction confirmation to the remote electronic device using the contact information. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, when one or more processors of an electronic device determine that an electronic payment transaction has been initiated and completed, identifying an electronic payment transaction recipient of the electronic payment transaction using information from a contact database accessible to the one or more processors from contextual information extracted from an electronic payment transaction confirmation, detecting a request for the communication device to transmit a screenshot of the electronic payment transaction confirmation, and presenting one or more potential recipients for the screenshot of the electronic payment transaction confirmation on the user interface as described herein. The non-processor circuits may include, but are not limited to, a radio receiver, a radio transmitter, signal drivers, clock circuits, power source circuits, and user input devices.

As such, these functions may be interpreted as steps of a method to perform detecting, with one or more processors, initiation and completion of an electronic payment transaction, identifying, with the one or more processors, one or more electronic payment transaction recipients of the electronic payment transaction, also detecting, with the one or more processors, a screenshot capture of an electronic payment transaction confirmation presented on a user interface of the electronic device, comparing, with the one or more processors, the one or more electronic payment transaction recipients to a contact list available to the one or more processors to obtain one or more instances of contact information corresponding to the one or more electronic payment transaction recipients, and presenting, by the one or more processors on the user interface, at least one electronic payment transaction recipient found in the contact list on the user interface. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that in the realm of digital banking and electronic transactions, the practice of sharing payment confirmation screenshots has become increasingly prevalent. This method of sharing provides a visual confirmation of transactions, which is particularly useful in both personal and business contexts. For personal use, sharing payment confirmation screenshots simplifies the process of splitting bills, tracking shared expenses, and confirming transfers between family members. In business scenarios, sharing payment confirmation screenshots serves as proof of payment for services rendered, aids in record-keeping, and minimizes disputes. Additionally, in contexts such as condominium maintenance or shared utilities, sharing payment confirmation screenshots facilitates clear documentation of payments, ensuring accountability among residents or stakeholders.

Despite the utility, embodiments of the disclosure contemplate that the process of sharing payment screenshots presents several challenges. One significant issue is the precise selection of the recipient, which demands time and attention. This seemingly mundane task carries consequential risks, as inaccurate recipient selection can lead to sensitive financial information being sent to unintended recipients, posing privacy and security threats. Furthermore, in specific scenarios like condominium payments, users often need to direct screenshots to particular contacts, such as administrators or clerks managing financial reconciliations, adding complexity to the sharing process. Current solutions lack intuitive mechanisms to streamline this procedure, resulting in potential errors and inefficiencies.

To illustrate these challenges, consider a typical user of electronic banking transactions named Chuck. Imagine that Chuck recently spent his weekend multitasking, managing various payments while chatting with his former college buddy, Kermit. Exhausted from the flurry of transactions, he made a final payment for condominium maintenance. In the haze of fatigue, his finger, already engaged in conversation, inadvertently selected his friend's contact rather than that of the condominium superintendent—a mere milliseconds distraction resulting in an egregious mistake. Moments later, his phone buzzed with his buddy's bewildered response to the payment screenshot.

Mortified, Chuck realized the blunder—a confidential condominium payment shared with the wrong person, amplified by the recommendation system placing his buddy's contact at the top due to their ongoing conversation. This embarrassing mix-up highlighted the pitfalls of simultaneous interactions and the need for an enhanced system that mitigates errors arising from multitasking, ensuring seamless and secure payment sharing without risking sensitive information to unintended recipients.

Advantageously, embodiments of the disclosure address these challenges by providing an artificial intelligence (AI)-based sharing intent recommendation for screenshots captured during electronic payment transactions. In one or more embodiments, this system determines when a financial transaction has been initiated and completed, identifies the recipient of the transaction, and detects the initiation of a share intent for the payment screenshot. Optionally using AI techniques, in one or more embodiments the system extracts recipient information and correlates the recipient information with potential contacts or social groups on one or more social communication applications. In one or more embodiments, the system then prioritizes these contacts at the top of the list as recommendation options, ensuring that the screenshot reaches the correct recipient efficiently and securely. Additionally, in one or more embodiments the system records the user's choice for future use, further enhancing the accuracy and convenience of the sharing process. Advantageously, embodiments of the disclosure provide specific solutions that offer predictability of share intent to a specific contact or a social group post completion of a financial transaction.

In one or more embodiments, a method in can electronic device comprises receiving, at a user interface, user input completing an electronic payment transaction defining an electronic payment transaction recipient and resulting in presentation of an electronic payment transaction confirmation by the user interface. In one or more embodiments, the method comprises receiving, at the user interface, other user input requesting a communication device of the electronic device to transmit a screenshot of the electronic payment transaction confirmation to a remote electronic device.

In one or more embodiments, the method comprises extracting, by one or more processors from the screenshot of the electronic payment transaction confirmation, the electronic payment transaction recipient. In one or more embodiments, the method comprises correlating, by the one or more processors, the electronic payment transaction recipient with a contacts list accessible by the one or more processors to determine contact information for the electronic payment transaction recipient. In one or more embodiments, the method comprises causing, by the one or more processors, the communication device to transmit the screenshot of the electronic payment transaction confirmation to the remote electronic device using the contact information.

Advantageously, by receiving user input completing an electronic payment transaction and presenting an electronic payment transaction confirmation, the system ensures that the transaction details are accurately captured and displayed, providing a clear and immediate visual confirmation of the transaction. Receiving additional user input requesting the transmission of a screenshot of the electronic payment transaction confirmation to a remote electronic device allows the user to share transaction details efficiently and securely, reducing the risk of errors associated with manual entry of transaction information.

Extracting the electronic payment transaction recipient from the screenshot using one or more processors automates the identification process, minimizing the likelihood of human error and ensuring that the correct recipient is identified based on the transaction details. Correlating the electronic payment transaction recipient with a contacts list accessible by the processors to determine contact information streamlines the sharing process by automatically matching the recipient with their contact details, thus reducing the time and effort required by the user to manually search for and select the recipient. Causing the communication device to transmit the screenshot of the electronic payment transaction confirmation using the determined contact information ensures that the transaction details are sent to the correct recipient, enhancing the security and accuracy of the information sharing process. This reduces the risk of sensitive financial information being sent to unintended recipients, thereby improving user privacy and security.

In one or more embodiments, embodiments of the disclosure involve determining in an electronic device that a financial transaction has been initiated. In one or more embodiments, the system identifies the recipient of the transaction via a remote electronic device identifier, such as a phone number or Internet Protocol (IP) address. Upon detecting the initiation of a screen share, in one or more embodiments the system captures a screenshot of the financial transaction. In one or more embodiments, the system then correlates this information with a contacts list stored in an address book or communication application, such as WhatsApp.sup.™.

Optionally using artificial intelligence techniques, in one or more embodiments the system extracts recipient information and correlates the recipient information with potential contacts or social groups on one or more social communication applications. In one or more embodiments, the system prioritizes these contacts at the top of the list as recommendation options. Additionally, in one or more embodiments the system records the user's choice for future use, further enhancing the accuracy and convenience of the sharing process.

In one or more embodiments, the system also includes a feature that allows for the automatic generation of a memo line based on context and user history. For example, when communicating by email, the system could add the subject line and body of the text. This feature ensures that the screenshot reaches the correct recipient efficiently and securely, reducing the risk of sensitive financial information being sent to unintended recipients.

In one or more embodiments, an electronic device comprises a user interface, a communication device, and one or more processors operable with the user interface and the communication device. In one or more embodiments, the one or more processors are configured to determine that an electronic payment transaction has been initiated and completed. In one or more embodiments, the one or more processors further identify an electronic payment transaction recipient of the electronic payment transaction using information from a contact database accessible to the one or more processors from contextual information extracted from an electronic payment transaction confirmation, detect a request for the communication device to transmit a screenshot of the electronic payment transaction confirmation, and present one or more potential recipients for the screenshot of the electronic payment transaction confirmation on the user interface.

By configuring the one or more processors to determine that an electronic payment transaction has been initiated and completed, the system ensures that the transaction details are accurately captured and processed in real-time, providing immediate feedback to the user and reducing the likelihood of errors associated with manual tracking of transactions.

Identifying an electronic payment transaction recipient using information from a contact database accessible to the one or more processors from contextual information extracted from an electronic payment transaction confirmation automates the recipient identification process. This reduces the time and effort required by the user to manually search for and select the recipient, thereby enhancing user efficiency and minimizing the risk of selecting the wrong recipient.

Detecting a request for the communication device to transmit a screenshot of the electronic payment transaction confirmation ensures that the system is responsive to user actions, enabling seamless and timely sharing of transaction details. This feature supports user convenience by allowing quick and accurate sharing of payment confirmations.

Presenting one or more potential recipients for the screenshot of the electronic payment transaction confirmation on the user interface provides a user-friendly mechanism for selecting the correct recipient. This arrangement minimizes the risk of sending sensitive financial information to unintended recipients, thereby enhancing the security and privacy of the transaction details.

In one or more embodiments, a method in an electronic device comprises detecting, with one or more processors, initiation and completion of an electronic payment transaction. In one or more embodiments, the method comprises identifying, with the one or more processors, one or more electronic payment transaction recipients of the electronic payment transaction.

In one or more embodiments, the method comprises also detecting, with the one or more processors, a screenshot capture of an electronic payment transaction confirmation presented on a user interface of the electronic device. In one or more embodiments, the method comprises comparing, with the one or more processors, the one or more electronic payment transaction recipients to a contact list available to the one or more processors to obtain one or more instances of contact information corresponding to the one or more electronic payment transaction recipients and presenting, by the one or more processors on the user interface, at least one electronic payment transaction recipient found in the contact list on the user interface.

Detecting, with one or more processors, initiation and completion of an electronic payment transaction can involve monitoring the electronic device for signals or data indicative of a financial transaction. The processors can identify the start of the transaction by recognizing user actions such as entering payment details or confirming a payment. The completion of the transaction can be detected when the system receives a confirmation signal or message from the payment processing entity, indicating that the transaction has been successfully processed.

Identifying, with the one or more processors, one or more electronic payment transaction recipients of the electronic payment transaction can be facilitated when the system analyzes the transaction data to determine the intended recipient. This may involve extracting information such as the recipient's name, phone number, email address, or other identifiers from the transaction details. The processors can then compare this information against a contact list stored on the device or accessible through a connected service to find matching contact entries.

Also detecting, with the one or more processors, a screenshot capture of an electronic payment transaction confirmation presented on a user interface of the electronic device can involve monitoring the device's screen activity. When the user takes a screenshot, the system can recognize this action and captures the image of the transaction confirmation displayed on the screen. This screenshot can serve as a visual record of the transaction details, including the recipient information and transaction amount.

Comparing, with the one or more processors, the one or more electronic payment transaction recipients to a contact list available to the one or more processors to obtain one or more instances of contact information corresponding to the one or more electronic payment transaction recipients can involve cross-referencing the extracted recipient information with the entries in the contact list. In one or more embodiments, the system searches for matches based on identifiers such as names, phone numbers, or email addresses. When a match is found, the system retrieves the corresponding contact information, which may include multiple instances if the recipient has multiple contact methods.

Presenting, by the one or more processors on the user interface, at least one electronic payment transaction recipient found in the contact list on the user interface involves displaying the identified recipient(s) to the user. The system may present a list of potential recipients, prioritizing them based on factors such as frequency of past transactions or relevance to the current transaction. This allows the user to quickly and accurately select the correct recipient for sharing the transaction confirmation screenshot, thereby enhancing the efficiency and security of the sharing process.

By recording the amount of the electronic payment transaction and the electronic payment transaction recipient in a payment share database stored in the memory of the electronic device, the system ensures that there is a historical record of transactions and their corresponding recipients. This historical data can be used to enhance the accuracy of future recipient suggestions, as the system can learn from past transactions to predict the most likely recipients for new transactions. This reduces the likelihood of errors in recipient selection, thereby improving the efficiency and security of the sharing process.

Additionally, maintaining a record of transaction amounts and recipients allows for better tracking and management of financial transactions. Users can easily reference past transactions, which is particularly useful for personal budgeting, expense tracking, and resolving any disputes that may arise regarding payments. This feature enhances the overall user experience by providing a reliable and accessible way to manage and review financial transactions. Other advantages will be described below. Still others will be obvious to those of ordinary skill in the art having the benefit of this disclosure.

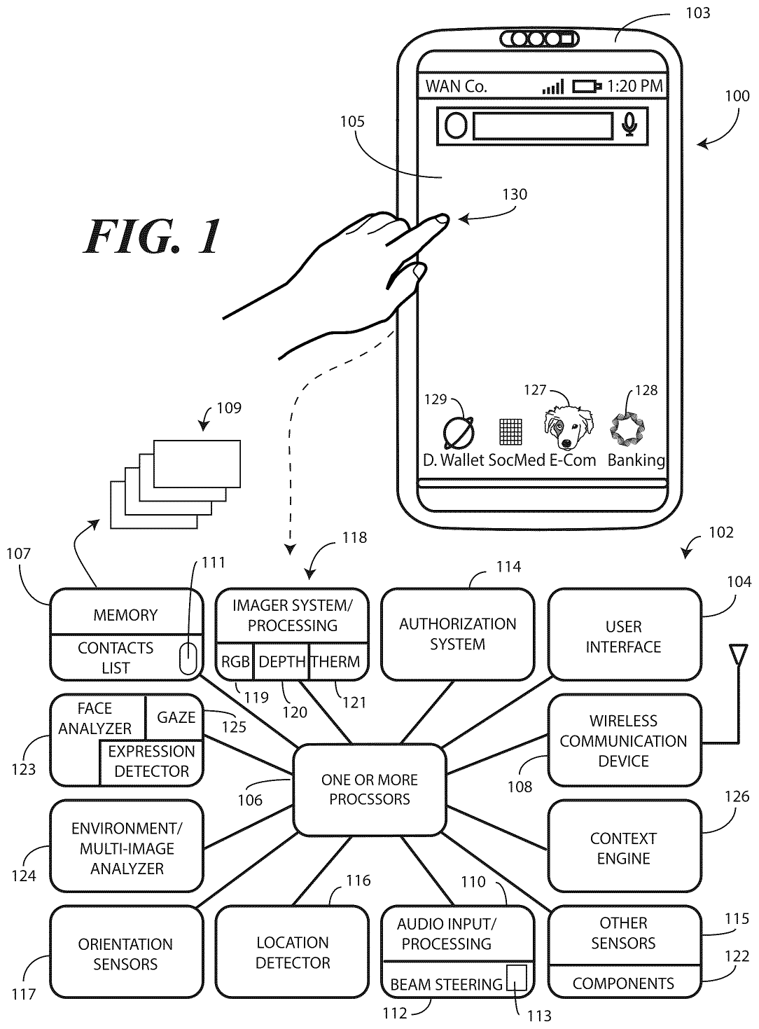

Turning now to FIG. 1, illustrated therein is one explanatory electronic device 100 in accordance with one or more embodiments of the disclosure. Also illustrated in FIG. 1 is one explanatory block diagram schematic 102 of the explanatory electronic device 100 of FIG. 1. In one or more embodiments, the block diagram schematic 102 is configured as a printed circuit board assembly disposed within a housing 103 of the electronic device 100. Various components can be electrically coupled together by conductors, or a bus disposed along one or more printed circuit boards.

The illustrative block diagram schematic 102 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

The illustrative block diagram schematic 102 includes a user interface 104. In one or more embodiments, the user interface 104 includes a display 105, which may optionally be touch-sensitive. In one embodiment, users can deliver user input to the display 105 of such an embodiment by delivering touch input from a finger, stylus, or other objects disposed proximately with the display 105. In one embodiment, the display 105 is configured as an active matrix organic light emitting diode (AMOLED) display. However, it should be noted that other types of displays, including liquid crystal displays, suitable for use with the user interface 104 would be obvious to those of ordinary skill in the art having the benefit of this disclosure.

In one embodiment, the electronic device includes one or more processors 106. In one embodiment, the one or more processors 106 can include an application processor and, optionally, one or more auxiliary processors. One or both of the application processor or the auxiliary processor(s) can include one or more processors.

One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 102. Each of the application processor and the auxiliary processor(s) can be configured to process and execute executable software code to perform the various functions of the electronic device with which the block diagram schematic 102 operates. A storage device, such as memory 107, can optionally store the executable software code used by the one or more processors 106 during operation.

In one or more embodiments, the one or more processors 106 are responsible for running the operating system environment. The operating system environment can include a kernel, one or more drivers, and an application service layer, and an application layer. The operating system environment can be configured as executable code operating on one or more processors 106 or control circuits of the electronic device 100.

The application service layer can be responsible for executing application service modules. The application service modules may support one or more applications or “apps.” Examples of such applications include a cellular telephone application for making voice telephone calls, a web browsing application configured to allow the user to view webpages on the display 105 of the electronic device 100, an electronic mail application configured to send and receive electronic mail, a photo application configured to organize, manage, and present photographs on the display 105 of the electronic device 100, and a camera application for capturing images with the imager 119. Collectively, these applications constitute an “application suite.” In one or more embodiments, these applications comprise one or more e-commerce applications 127 and/or banking applications 128 that allow electronic commerce orders to be placed and financial transactions to be made using the electronic device 100.

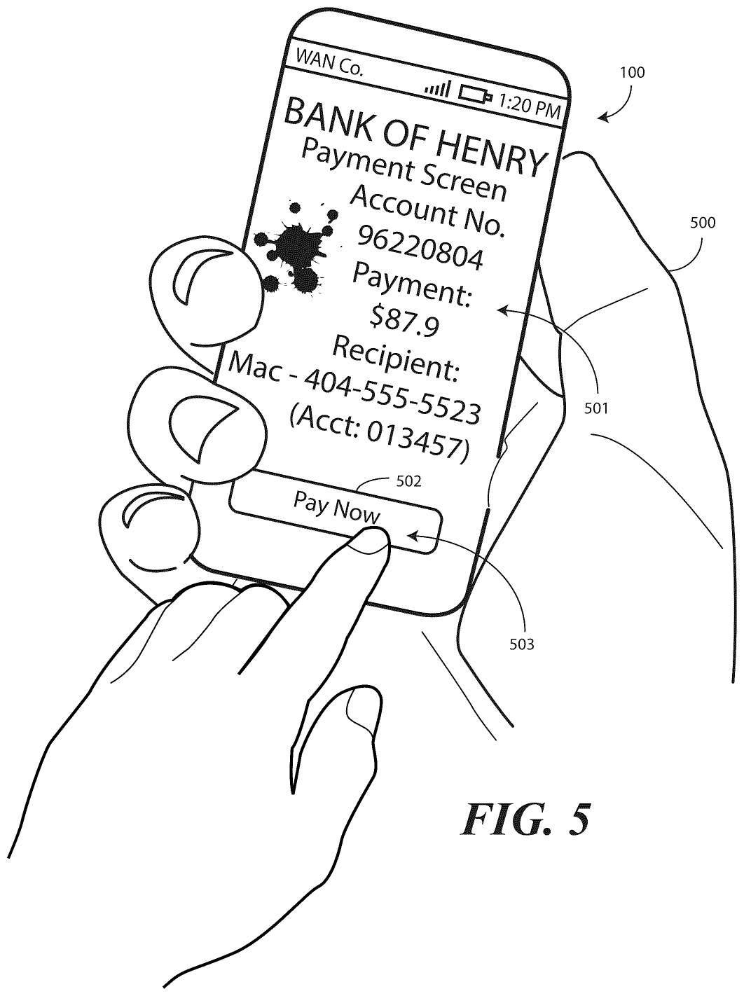

Illustrating by example, in one or more embodiments a user can deliver user input to an e-commerce application 127 or a banking application 128 to enter an electronic payment transaction request or otherwise request an electronic payment transaction occur. Thereafter, the user interface 104 can receive user input completing the electronic payment transaction to an electronic payment transaction recipient. In one or more embodiments, this results in the presentation of an electronic payment transaction confirmation by the user interface 104. One such example of an electronic payment transaction confirmation is shown in FIG. 5.

Turning briefly to FIG. 5, illustrated therein is a user 500 using an electronic device 100 configured in accordance with one or more embodiments of the disclosure. In this illustrative example, the user 500 is delivering user input 503 to a user actuation target 502 causing completion of an electronic payment transaction of eighty-seven dollars and ninety cents to Mac, who is identified on the electronic payment transaction confirmation 501 presented on the display.

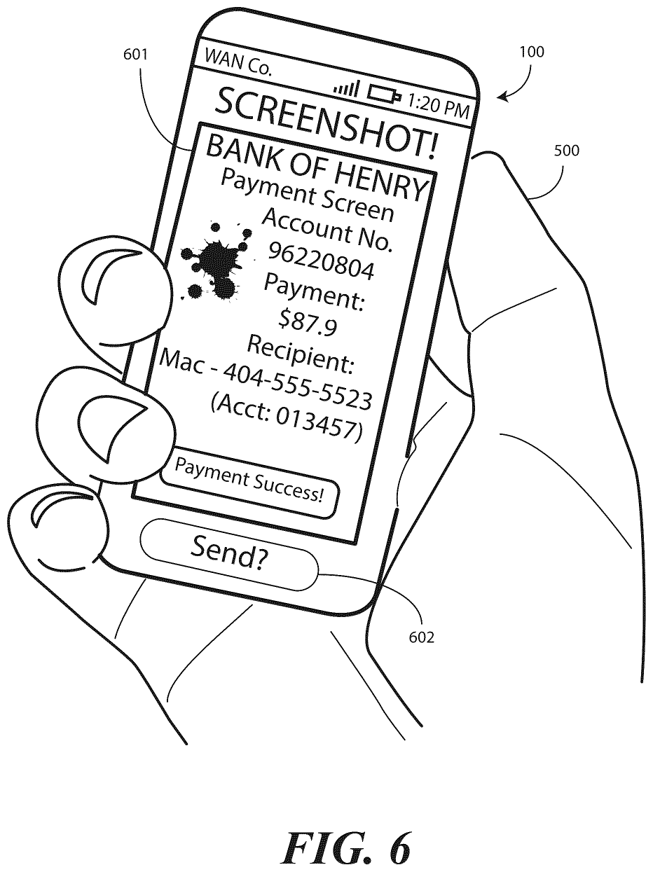

Turning now back to FIG. 1, in one or more embodiments the user interface 104 can then receive other user input 130 requesting a communication device 108 of the electronic device 100 transmit a screenshot of the electronic payment transaction confirmation to a remote electronic device. Turning briefly to FIG. 6, illustrated therein is one such screenshot 601.

As shown in FIG. 5, the user 500 has delivered other user input to the user interface (104) of the electronic device to cause a screenshot 601 of the electronic payment transaction confirmation (501). In one or more embodiments, the user interface (104) causes a user actuation target 602 to be presented as well. In one or more embodiments, actuation of the user actuation target 602 causes the screenshot 601 of the electronic payment transaction confirmation to be transmitted to another electronic device across a network.

As noted above, with prior art systems the user 500 would need to identify the remote electronic device prior to the user actuation target 602 working. This process of sharing payment screenshots presents several challenges, primarily revolving around the precise selection of this recipient. This task demands time and attention, and any inaccuracies in recipient selection can lead to sensitive financial information being sent to unintended recipients, posing privacy and security threats. In scenarios such as condominium payments, users often need to direct screenshots to specific contacts, such as administrators or clerks managing financial reconciliations, adding complexity to the sharing process.

Advantageously, turning now back to FIG. 1, embodiments of the disclosure provide a solution to these issues, thereby streamlining this procedure, resulting in far fewer potential errors and inefficiencies. Indeed, embodiments of the disclosure streamline the sharing process by offering intuitive mechanisms that swiftly identify and suggest relevant contacts for different types of payments. Such a solution alleviates the risk of misdirected information and enhances user efficiency, ensuring screenshots reach the right recipients without compromising sensitive financial data. The system also records user choices for future use, further improving the accuracy and convenience of the sharing process.

In one or more embodiments, the one or more processors 106 of the electronic device 100 extract, from the screenshot (601) of the electronic payment transaction confirmation (501), an electronic payment transaction recipient. In one or more embodiments, the one or more processors 106 then correlate the electronic payment transaction recipient with a contacts list 111 accessible to the one or more processors 106 to determine contact information for the electronic payment transaction recipient. In one or more embodiments, the one or more processors 106 then cause the communication device 108 to transmit the screenshot (601) of the electronic payment transaction confirmation (501).

In this illustrative embodiment, the block diagram schematic 102 also includes a communication circuit 108 that can be configured for wired or wireless communication with one or more other devices or networks. The networks can include a wide area network, a local area network, and/or personal area network. The communication circuit 108 may also utilize wireless technology for communication, such as, but are not limited to, peer-to-peer or ad hoc communications such as HomeRF, Bluetooth and IEEE 802.11, and other forms of wireless communication such as infrared technology. The communication circuit 108 can include wireless communication circuitry, one of a receiver, a transmitter, or transceiver, and one or more antennas.

In one embodiment, the one or more processors 106 can be responsible for performing the primary functions of the electronic device with which the block diagram schematic 102 is operational. For example, in one embodiment the one or more processors 106 comprise one or more circuits operable with the user interface 104 to present presentation information to a user. The executable software code used by the one or more processors 106 can be configured as one or more modules 109 that are operable with the one or more processors 106. Such modules 109 can store instructions, control algorithms, and so forth.

In one or more embodiments, the block diagram schematic 102 includes an audio input/processor 110. The audio input/processor 110 is operable to receive audio input from an environment about the electronic device 100. The audio input/processor 110 can include hardware, executable code, and speech monitor executable code in one embodiment. The audio input/processor 110 can be operable with one or more predefined authentication references 111 stored in memory 107.

With reference to audio input, the predefined authentication references 111 can comprise representations of basic speech models, representations of trained speech models, or other representations of predefined audio sequences that are used by the audio input/processor 110 to receive and identify voice commands that are received with audio input captured by an audio capture device. In one embodiment, the audio input/processor 110 can include a voice recognition engine. Regardless of the specific implementation utilized in the various embodiments, the audio input/processor 110 can access various speech models stored with the predefined authentication references 111 to identify speech commands.

The audio input/processor 110 can include a beam steering engine 112 comprising one or more microphones 113. Input from the one or more microphones 113 can be processed in the beam steering engine 112 such that the one or more microphones define a virtual microphone.

This virtual microphone can define an acoustic reception cone that can be virtually “steered” around the electronic device 100. Alternatively, actual steering can occur as well, such as switching between a left and right microphone or a front and back microphone or switching various microphones ON and OFF individually. In one or more embodiments, two or more microphones 113 can be included for selective beam steering by the beam steering engine 112.

Illustrating by example, a first microphone can be located on a first side of the electronic device 100 for receiving audio input from a first direction, while a second microphone can be placed on a second side of the electronic device 100 for receiving audio input from a second direction. These microphones can be “steered”by selectively turning them ON and OFF.

The beam steering engine 112 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 112 alerting it in which direction to focus the acoustic reception cone and/or steer the first microphone and the second microphone, thereby adding confirmation to audio steering and saving time. Where multiple people are around the electronic device 100, as was the case in FIG. 1, this steering advantageously directs a beam reception cone to the authorized user.

Alternatively, the beam steering engine 112 processes and combines the signals from two or more microphones to perform beam steering. The one or more microphones 113 can be used for voice commands. In response to control of the one or more microphones 113 by the beam steering engine 112, a user location direction can be determined. The beam steering engine 112 can then select between the first microphone and the second microphone to beam steer audio reception toward the user. Alternatively, the audio input/processor 110 can employ a weighted combination of the microphones to beam steer audio reception toward the user.

In one embodiment, the audio input/processor 110 is configured to implement a voice control feature that allows a user to speak a specific device command to cause the one or more processors 106 to execute a control operation. For example, the user may say, “Authenticate Me Now.” This statement comprises a device command requesting the one or more processors to cooperate with the authentication system 114 to authenticate a user. Consequently, this device command can cause the one or more processors 106 to access the authentication system 114 and begin the authentication process. In short, in one embodiment the audio input/processor 110 listens for voice commands, processes the commands and, in conjunction with the one or more processors 106, performs a touchless authentication procedure in response to voice input.

The one or more processors 106 can perform filtering operations on audio input received by the audio input/processor 110. For example, in one embodiment the one or more processors 106 can filter the audio input into authorized user generated audio input, i.e., first audio input, and other audio input, i.e., second audio input.

Various sensors 115 can be operable with the one or more processors 106. A first example of a sensor that can be included with the various sensors 115 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 106, to detect an object in close proximity with-or touching-the surface of the display 105 or the housing 103 of the electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor 115 is a geo-locator that serves as a location detector 116. In one embodiment, location detector 116 is able to determine location data when authenticating a user. Location can be determined by capturing the location data from a constellation of one or more earth orbiting satellites, or from a network of terrestrial base stations to determine an approximate location. The satellite positioning systems based location fixes of the location detector 116 autonomously or with assistance from terrestrial base stations, for example those associated with a cellular communication network or other ground based network, or as part of a Differential Global Positioning System (DGPS), as is well known by those having ordinary skill in the art. The location detector 116 may also be able to determine location by locating or triangulating terrestrial base stations of a traditional cellular network, or from other local area networks, such as Wi-Fi networks.

One or more motion detectors can be configured as an orientation detector 117 that determines an orientation and/or movement of the electronic device 100 in three-dimensional space. Illustrating by example, the orientation detector 117 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector 117 can determine the spatial orientation of an electronic device 100 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

The authentication system 114 is operable with the one or more processors 106. A first authenticator 118 of the authentication system 114 can include an imager 119, a depth imager 120, and, optionally, a thermal sensor 121. In one embodiment, the imager 119 comprises a two-dimensional imager configured to receive at least one image of a person within an environment of the electronic device 100. In one embodiment, the imager 119 comprises a two-dimensional Red-Green-Blue (RGB) imager. In another embodiment, the imager 119 comprises an infrared imager. Other types of imagers suitable for use as the imager 119 of the authentication system will be obvious to those of ordinary skill in the art having the benefit of this disclosure.

The thermal sensor 121 can also take various forms. In one embodiment, the thermal sensor 121 is simply a proximity sensor component included with the other components 122 of the electronic device 100. In another embodiment, the thermal sensor 121 comprises a simple thermopile. In another embodiment, the thermal sensor 121 comprises an infrared imager that captures the amount of thermal energy emitted by an object. Other types of thermal sensors 121 will be obvious to those of ordinary skill in the art having the benefit of this disclosure.

The depth imager 120 can take a variety of forms. In a first embodiment, the depth imager 120 comprises a pair of imagers separated by a predetermined distance, such as three to four images. This “stereo” imager works in the same way the human eyes do in that it captures images from two different angles and reconciles the two to determine distance.

In another embodiment, the depth imager 120 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 120 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager 119, thereby enhancing the security of using a person's face as their password in the process of authentication by facial recognition.

In one or more embodiments, the authentication system 114 can be operable with a face analyzer 123 and an environmental analyzer 124. The face analyzer 123 and/or environmental analyzer 124 can be configured to process an image or depth scan of an object and determine whether the object matches predetermined criteria by comparing the image or depth scan to one or more predefined authentication references 111 stored in memory 107.

For example, the face analyzer 123 and/or environmental analyzer 124 can operate as an authentication module configured with optical and/or spatial recognition to identify objects using image recognition, character recognition, visible recognition, facial recognition, color recognition, shape recognition, and the like. Advantageously, the face analyzer 123 and/or environmental analyzer 124, operating in tandem with the authentication system 114, can be used as a facial recognition device to determine the identity of one or more persons detected about the electronic device 100.

In one embodiment when the authentication system 114 detects a person, one or both of the imager 119 and/or the depth imager 120 can capture a photograph and/or depth scan of that person. The authentication system 114 can then compare the image and/or depth scan to one or more predefined authentication references 111 stored in the memory 107. This comparison, in one or more embodiments, is used to confirm beyond a threshold authenticity probability that the person's face-both in the image and the depth scan-sufficiently matches one or more of the predefined authentication references 111 stored in the memory 107 to authenticate a person as an authorized user of the electronic device 100.

Beneficially, this optical recognition performed by the authentication system 114 operating in conjunction with the face analyzer 123 and/or environmental analyzer 124 allows access to the electronic device 100 only when one of the persons detected about the electronic device 100 are sufficiently identified as an authorized user of the electronic device 100.

Accordingly, in one or more embodiments the one or more processors 106, working with the authentication system 114 and the face analyzer 123 and/or environmental analyzer 124 can determine whether at least one image captured by the imager 119 matches a first predefined criterion, whether at least one facial depth scan captured by the depth imager 120 matches a second predefined criterion, and whether the thermal energy identified by the thermal sensor 121 matches a third predefined criterion, with the first criterion, second criterion, and third criterion being defined by the reference files and predefined temperature range.

The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 106 authenticate a person as an authorized user of the electronic device 100 when the at least one image matches the first predefined criterion, the at least one facial depth scan matches the second predefined criterion, and the thermal energy matches the third predefined criterion.

In one or more embodiments, a user can “train” the electronic device 100 by storing predefined authentication references 111 in the memory 107 of the electronic device 100. These predefined authentication references 111 can be audio references, image references, depth scan references, or other types of references. Illustrating by example, the one or more processors 106 of the electronic device 100 may cause the one or more microphones 113 to capture audio samples of people situated within the environment of the electronic device 100 so that the same people can be identified at another time.

The audio input/processing module 110 can capture audio signals from the environment using one or more microphones 113. These audio signals can then be processed to extract relevant audio features. The audio input/processing module 110 can compare these extracted audio features to one or more predefined authentication references 111 stored in the memory 107. These predefined authentication references 111 may include voice samples from previous interactions, voice messages, or manually uploaded voice samples. By comparing the captured audio features to the stored references, the system can identify individuals present within the environment of the electronic device 100.

The audio input/processing module 110 can also employ a voice recognition engine to analyze the captured audio signals. This engine, where used, can extract voice recognition features and generate a voiceprint for each detected voice. The voice recognition engine can then compare these voiceprints to the predefined authentication references 111. If a match is found, the system can identify the individual associated with the voiceprint. This process allows the system to dynamically and contextually identify individuals present during a financial transaction or other events, ensuring accurate identification of participants.

In scenarios where multiple individuals are present, the audio input/processing module 110 can distinguish between different voices by analyzing voice characteristics such as pitch, tone, and speech patterns. The system can then cross-reference these characteristics with the predefined authentication references 111 to accurately identify each individual. This capability is particularly useful in environments where participants may join or leave at different times, ensuring that the system maintains an up-to-date and accurate list of individuals present.

Similarly, a user may take a series of pictures. They can include identifiers of special features such as eye color, sink color, air color, weight, and height. They can include the user standing in front of a particular wall, which is identifiable by the environmental analyzer from images captured by the imager 119. They can include the user raising a hand, touching hair, or looking in one direction, such as in a profile view. These can then be stored as predefined authentication references 111 in the memory 107 of the electronic device 100.

A gaze detector 125 can be operable with the authentication system 114 operating in conjunction with the face analyzer 123. The gaze detector 125 can comprise sensors for detecting the user's gaze point. The gaze detector 125 can optionally include sensors for detecting the alignment of a user's head in three-dimensional space. Electronic signals can then be processed for computing the direction of user's gaze in three-dimensional space. The gaze detector 125 can further be configured to detect a gaze cone corresponding to the detected gaze direction, which is a field of view within which the user may easily see without diverting their eyes or head from the detected gaze direction. The gaze detector 125 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 125 of FIG. 1.

The face analyzer 123 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 119 or the depth imager 120 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 122 operable with the one or more processors 106 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 122 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 103 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 106 can cause each proximity sensor component to operate at a first “effective” sensitivity so as to receive infrared emissions from a first distance. Similarly, the one or more processors 106 can cause each proximity sensor component to operate at a second sensitivity, which is less than the first sensitivity, so as to receive infrared emissions from a second distance, which is less than the first distance. The sensitivity change can be affected by causing the one or more processors 106 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 122 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 122 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine 126 can then be operable with the various sensors to detect, infer, capture, and otherwise determine persons and actions that are occurring in an environment about the electronic device 100. For example, where included one embodiment of the context engine 126 determines assessed contexts and frameworks using adjustable algorithms of context assessment employing information, data, and events. These assessments may be learned through repetitive data analysis. Alternatively, a user may employ the user interface 104 to enter various parameters, constructs, rules, and/or paradigms that instruct or otherwise guide the context engine 126 in detecting multi-modal social cues, emotional states, moods, and other contextual information. The context engine 126 can comprise an artificial neural network or other similar technology in one or more embodiments.

In one or more embodiments, the context engine 126 is operable with the one or more processors 106. In some embodiments, the one or more processors 106 can control the context engine 126. In other embodiments, the context engine 126 can operate independently, delivering information gleaned from detecting multi-modal social cues, emotional states, moods, and other contextual information to the one or more processors 106. The context engine 126 can receive data from the various sensors. In one or more embodiments, the one or more processors 106 are configured to perform the operations of the context engine 126.

In one or more embodiments, the one or more processors 106 can be operable with the various authenticators of the authentication system 114. For example, the one or more processors 106 can be operable with a first authenticator and a second authenticator. Where more authenticators are included in the authentication system 114, the one or more processors 106 can be operable with these authenticators as well.

As will be described in more detail below, in one or more embodiments the one or more processors 106 are configured to determine that an electronic payment transaction has been initiated and completed, identify an electronic payment transaction recipient of the electronic payment transaction using information from a contact database 130 accessible to the one or more processors 106 from contextual information extracted from an electronic payment transaction confirmation by the context engine 126. In one or more embodiments, the one or more processors 106 are further configured to detect a request for the communication device 108 to transmit a screenshot of the electronic payment transaction confirmation, and present one or more potential recipients for the screenshot of the electronic payment transaction confirmation on the user interface 104.

In one or more embodiments, the one or more processors 106 are responsible for managing the applications and all personal information received from the user interface 104 that is to be used by the finance application 127 and/or banking application 128 after the electronic device 100 is authenticated as a secure electronic device and the user identification credentials have triggered an electronic payment transaction request. The one or more processors 106 can also be responsible for launching, monitoring, and killing the various applications and the various application service modules.

In one or more embodiments, the one or more processors 106 are operable to not only kill the applications, but also to expunge any and all personal data, data, files, settings, or other configuration tools when the electronic device 100 is reported stolen or when the finance application 127 and/or banking application 128 are used with fraudulent activity to wipe the memory 107 clean of any personal data, preferences, or settings of the person previously using the electronic device 100.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

Embodiments of the disclosure contemplate that an electronic financial transaction can be initiated for any number of a variety of reasons. Additionally, screenshots of the electronic financial transaction confirmation can be delivered to a variety of people. Moreover, the screenshot of the electronic financial transaction confirmation may be sent to recipients other than to whom the electronic financial transaction was made. Examples of each of these variations will be described in more detail with reference to the figures that follow.

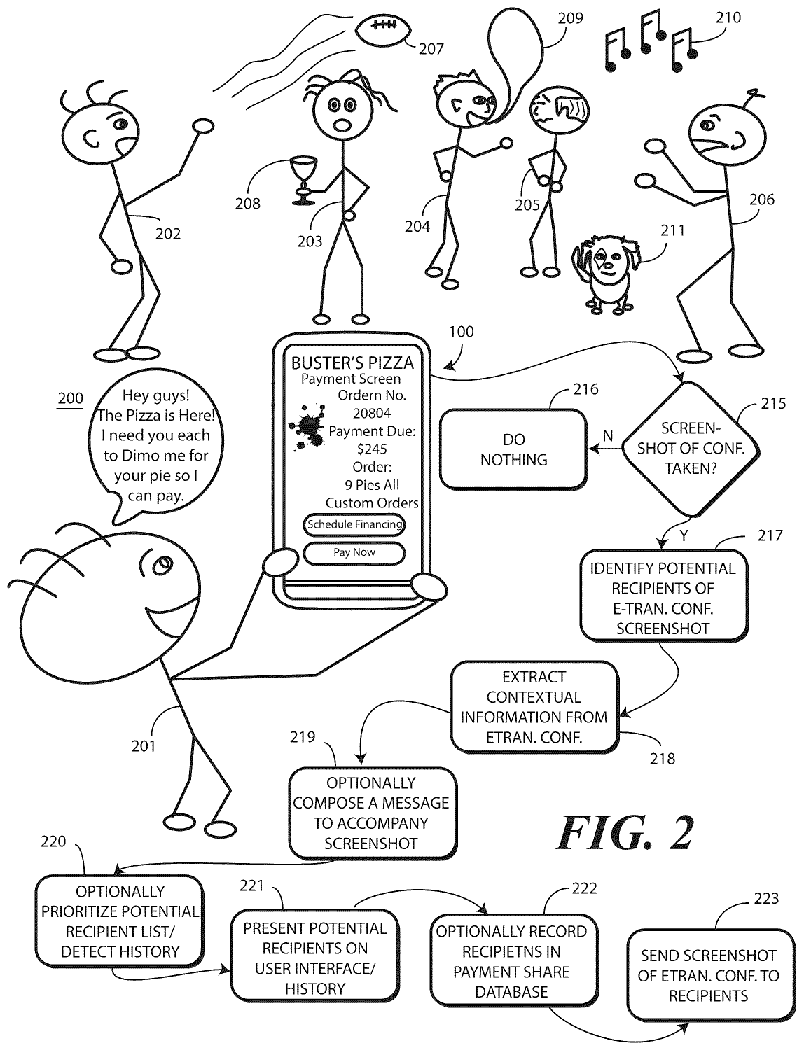

Illustrating by example, turning now to FIG. 2, illustrated therein is one explanatory system configured in accordance with one or more embodiments of the disclosure. An electronic device 100 is positioned within an environment 200. A plurality of persons 201,202,203,204,205,206 is situated within the environment 200 of the electronic device 100. Here, there are six persons 201,202,203,204,205,206 situated within the environment of the electronic device 100. Person 201, Ernest, is an authorized user of the electronic device 100.

In the illustrative embodiment of FIG. 2, persons 202,203,204,205,206 are friends, family, or acquaintances of the authorized user. Persons 202,203,204,205,206 may be authorized by the authorized user to use the electronic device 100 in one or more embodiments. In other embodiments, persons 202,203,204,205,206 may be unauthorized users of the electronic device 100.

In this illustration, used to more particularly describe various features and advantages of embodiments of the disclosure, there is a lot occurring. The scene set forth in the environment 200 of the electronic device 100 is not dissimilar to that which may occur at a family gathering, family reunion, school reunion, and so forth. In this illustration, person 202 is passing a football 207 to person 206. Person 203 is watching the action while sipping on a cocktail 208. Person 204 is having a conversation 209 with person 205. Music 210 is playing. A dog 211 is enjoying the weather and dreaming of his next meal.

Ernest has ordered pizza for the group. The pizza comes from Buster's Pizza, which is world famous for its amazing thin crust pizzas. Indeed, in the illustrative example shown in FIG. 2, the group has decided to indulge in a feast from Buster's Pizza, renowned worldwide for its exceptional quality and unique offerings. The hefty price tag of two hundred and forty-five dollars for nine pies might seem steep at first glance, but it reflects the unparalleled culinary experience that Buster's Pizza provides. Each pie is crafted with the finest ingredients, from hand-tossed dough made with imported Italian flour to the freshest, locally sourced toppings.

The meticulous attention to detail and commitment to quality are what set Buster's apart from the rest.

Buster's Pizza offers a diverse menu that caters to all tastes and preferences. Their signature Truffle Mushroom Pizza, topped with a blend of wild mushrooms, truffle oil, and a sprinkle of fresh arugula, is a favorite among food critics and pizza aficionados alike. Another standout is the Margherita Supreme, which elevates the classic Margherita with heirloom tomatoes, buffalo mozzarella, and a drizzle of aged balsamic reduction. For those who enjoy a bit of spice, the Spicy Sausage and Peppers Pizza, featuring house-made sausage, roasted red peppers, and a fiery chili oil, is sure to satisfy.

The acclaim for Buster's Pizza extends far beyond its loyal customer base. Renowned food critics have lauded Buster's for its innovative approach to pizza-making and its unwavering dedication to quality. The East Broadway Times described Buster's as “a revelation in the world of pizza,” while Pizza & More Pizza magazine hailed it as “the pinnacle of pizza perfection.” These glowing reviews are a testament to the exceptional dining experience that Buster's consistently delivers.

Given the premium ingredients, artisanal craftsmanship, and critical acclaim, it's no surprise that Buster's Pizza commands a higher price. Each bite is a testament to the passion and expertise that go into every pie, making it worth every penny. So, while two hundred and forty-five dollars for nine pies might seem expensive, it's a small price to pay for a taste of what many consider to be the best pizza on the planet.

Ordinarily, splitting the bill among these persons 202,203,204,205,206, especially during this moment of joy and whimsy, would be nearly impossible. However, Ernest's electronic device 100, configured in accordance with one or more embodiments of the disclosure, can do this quickly, accurately, and automatically.

One or more processors of the electronic device 100 detect a financial transaction, which is the pizza order in this illustrative example, having a transaction amount using a digital wallet application operable on one or more processors of the electronic device 100. In one or more embodiments, the one or more processors detect a financial transaction having a transaction amount using a digital wallet application by monitoring the application for specific transaction-related events.

Illustrating by example, in one or more embodiments the user interface of the electronic device 100 receives user input completing an electronic payment transaction. As described above, in one or more embodiments this results in the presentation of an electronic payment transaction confirmation on the user interface, one example of which is shown in FIG. 5.

In one or more embodiments, the digital wallet application, operable on the one or more processors, generates transaction events when a user initiates or completes a financial transaction. These events include data packets containing transaction details such as the transaction amount, merchant information, and timestamp. The processors can continuously, or periodically, scan the digital wallet application's event logs or transaction history to identify these transaction events.

Upon detecting a transaction event, the processors extract the relevant transaction details from the data packets. This extraction process involves parsing the data packets to retrieve the transaction amount, which is a numerical value representing the monetary value of the transaction. The processors can also identify other contextual information associated with the transaction, such as the merchant's name, location, and the time of the transaction. This contextual information helps in correlating the transaction with potential bill-splitting scenarios.

In addition to monitoring the digital wallet application's internal events, the processors may also utilize external signals to confirm the occurrence of a financial transaction. These external signals can include notifications from banking servers, confirmation messages from payment gateways, or receipts sent to the user's email or messaging applications. By cross-referencing the internal transaction events with these external signals, the processors ensure the accuracy and validity of the detected financial transaction.

At decision 215, the one or more processors of the electronic device 100 determine whether user input has been received requesting a communication device of the electronic device 100 to transmit a screenshot of the electronic payment transaction confirmation to a remote electronic device. If no screenshot transmission request is received, step 216 does nothing.

When the user interface receives other user input requesting a communication device of the electronic device 100 to transmit a screenshot of the electronic payment transaction confirmation to a remote electronic device, step 217 identifies an electronic payment transaction recipient of the electronic payment transaction. In one or more embodiments, this step 217 uses information from a contact database that is accessible to the one or more processors from contextual information, which can be extracted from the electronic payment transaction confirmation, the environment 200, or by other techniques.

Step 218 optionally composes a message to accompany the screenshot of the electronic payment transaction confirmation. Where the electronic payment transaction recipient comprises a plurality of potential recipients, in one or more embodiments step 220 prioritizes the plurality of potential recipients. In one or more embodiments, this prioritization occurring at step 220 can be as a function of previous electronic payment transaction confirmation screenshots delivered to each potential recipient of the plurality of potential recipients. If, for example, person 202 has received many screenshots of electronic payment transaction confirmations from person 201, while person 206 has received none, person 202 may be prioritized over person 206 in one or more embodiments.

At step 221, the one or more processors present one or more potential recipients for the screenshot of the electronic payment transaction confirmation on the user interface. In one or more embodiments, this presentation presents the potential recipients in a list, wherein the list is prioritized as a function of previous electronic payment transaction confirmation screenshots delivered to each potential recipient of the plurality of potential recipients.

Optional step 222 records a user selection made from the list in a payment share database stored in the electronic device 100. Step 223 then sends the search string category of the electronic communication to the selected recipients.

In this illustrative example, Ernest wants persons 202,203,204,205,206 to chip in for the pizza. Sensors can then detect the persons 202,203,204,205,206 situated within the environment so that the one or more processors an identify them as potential electronic payment transaction recipients for the electronic payment transaction. Illustrating by example, the audio input device can capture audio samples from the environment 200, which the one or more processors analyze to extract relevant audio features. These features may include voice characteristics such as pitch, tone, and speech patterns. The one or more processors can compare these extracted audio features to predefined authentication references stored in the memory of the electronic device 100. These predefined authentication references may include voice samples from previous interactions, voice messages, or manually uploaded voice samples.

By comparing the captured audio features to the stored references, the one or more processors can identify individuals present within the environment 200 of the electronic device 100. The one or more processors employ a voice recognition engine to analyze the captured audio signals, extracting voice recognition features and generating a voiceprint for each detected voice. The voice recognition engine then compares these voiceprints to the predefined authentication references. If a match is found, the system identifies the individual associated with the voiceprint. This process allows the system to dynamically and contextually identify individuals present during a financial transaction, ensuring accurate identification of participants.

Where such individuals are identified, the one or more processors can compare these identified recipients to a contact list available to the one or more processors to obtain one or more instances of contact information corresponding to the identified recipients. The user interface can then present at least one electronic payment transaction recipient found in the contact list. User input can be received that selects an electronic payment transaction recipient presented on the user interface. The one or more processors can then cause the communication device to transmit the screenshot capture of the electronic payment transaction confirmation to the electronic payment transaction recipient using the contact information corresponding to the electronic payment transaction recipient. Additionally, an amount of the electronic payment transaction and the electronic payment transaction recipient can be recorded in a payment share database stored in a memory of the electronic device.

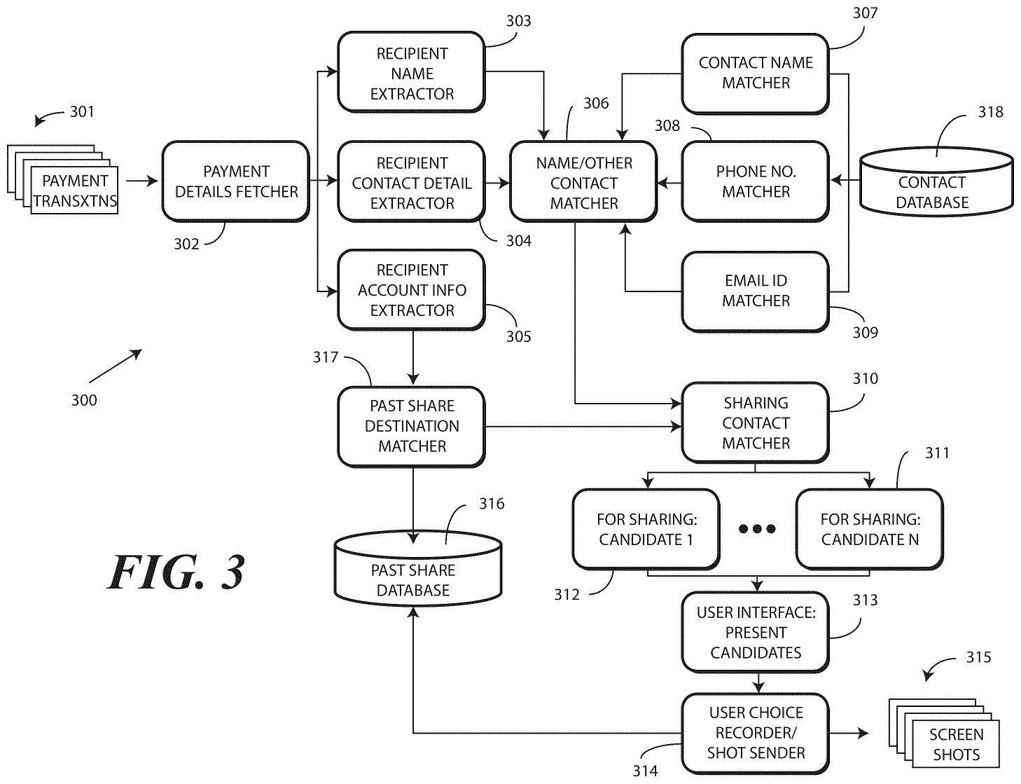

To further illustrate how embodiments of the disclosure can function, turn now to FIG. 3 where illustrated therein is one explanatory system 300 in accordance with one or more embodiments of the disclosure. The system 300 comprises several interconnected components designed to facilitate the identification and suggestion of potential recipients for screenshots of electronic payment transactions. The system 300 operates within the context of digital transactions, leveraging various data sources and processing modules to ensure accurate and efficient sharing of transaction confirmations.

The system 300 is initiated when user input initiates and completes one or more electronic payment transactions 301. In one or more embodiments, the electronic payment transactions 301 serve as the initial point of interaction within the system 300. A user interface of the system 300 can detect when a financial transaction has been initiated and completed. The user interface can monitor for signals or data indicative of a financial transaction, such as user actions entering payment details or confirming a payment, and confirmation signals from payment processing entities.

The payment details fetcher 302 retrieves detailed information about the detected financial transaction. This includes extracting transaction amounts, merchant information, timestamps, and other relevant contextual data from the transaction event logs or transaction history. The payment details fetcher 302 ensures that all necessary transaction details are available for subsequent processing steps.

The recipient name extractor 303 identifies the recipient of the financial transaction by analyzing the transaction details. This component extracts the recipient's name from the transaction confirmation or other contextual information associated with the transaction. The recipient name extractor 303 ensures that the correct recipient is identified for the sharing process. Illustrating by example, the recipient name extractor 303 can identify one or more electronic payment transaction recipients of the electronic payment transactions 301.

The recipient contact detail extractor 304 retrieves additional contact information for the identified recipient. This includes extracting phone numbers, email addresses, and other identifiers from the transaction details or associated contact databases. The recipient contact detail extractor 304 ensures that all necessary contact information is available for the sharing process.

The recipient account information extractor 305 component gathers account-specific information related to the recipient. This includes extracting details such as account numbers, payment methods, and other relevant account information from the transaction confirmation or associated databases. The recipient account information extractor 305 ensures that the recipient's account information is accurately captured and processed.

The name/other contact matcher 306 component compares the extracted recipient information with other information from a contact database 318 containing a contact list stored on the device or accessible through connected services. This component ensures that the recipient's contact details are accurately matched with the corresponding entries in the contact list, facilitating the sharing process.

Many different types of information can be used to match recipients extracted from the electronic payment transactions with the contact database 318. Illustrating by example, the contact name matcher 307 component can focus on matching the recipient's name with entries in the contact list. This component ensures that the recipient's name is accurately identified and correlated with the corresponding contact details, enhancing the accuracy of the sharing process.

The phone number matcher 308 component matches the recipient's phone number with entries in the contact list. This component ensures that the recipient's phone number is accurately identified and correlated with the corresponding contact details, facilitating the sharing process.

The email identification matcher 309 component matches the recipient's email address with entries in the contact list. This component ensures that the recipient's email address is accurately identified and correlated with the corresponding contact details, enhancing the accuracy of the sharing process.

The sharing contact matcher 310 component correlates the recipient information with potential contacts or social groups on one or more social communication applications. This component can optionally use artificial intelligence techniques to extract and prioritize potential contacts for the sharing process, ensuring that the most relevant contacts are suggested to the user.

Contact candidate 312 represents the first potential recipient, while contact candidate 311 represents the Nth potential recipient where N is an integer. These recipients are identified, and optionally prioritized, by the sharing contact matcher 310. These components ensure that the most relevant contacts are presented to the user for selection during the sharing process.

The user interface 313 component displays the identified and prioritized potential recipients to the user. This component provides a user-friendly mechanism for selecting the correct recipient, minimizing the risk of sending sensitive financial information to unintended recipients.

The user choice: record screenshot sender 314 component records the user's selection of the recipient for the screenshot. This component ensures that the user's choice is stored for future use, enhancing the accuracy and convenience of the sharing process.

The screenshots 315 component captures the visual confirmation of the financial transaction. This component ensures that the transaction details, including the recipient information and transaction amount, are accurately captured and available for sharing.

The past share destination matcher 317 component compares the current transaction details with previous sharing instances. This component ensures that the system can learn from past transactions to predict the most likely recipients for new transactions, enhancing the accuracy of the sharing process.

The past share destination database 316 component stores historical data of past transactions and their corresponding recipients. This component provides a reliable and accessible way to manage and review financial transactions, enhancing the overall user experience.

The contact database 318 component stores the contact information for potential recipients. This component ensures that all necessary contact details are available for the sharing process, facilitating accurate and efficient sharing of transaction confirmations.

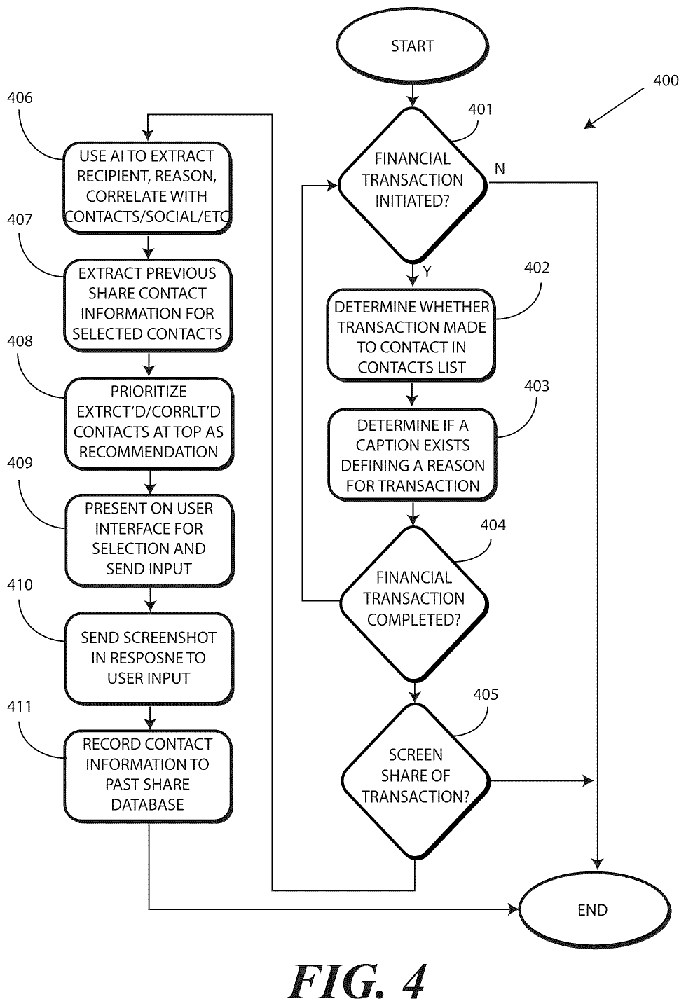

Turning now to FIG. 4, illustrated therein is one explanatory method 400 in accordance with one or more embodiments of the disclosure. The method 400 begins at decision 401, which determines whether an electronic payment transaction or electronic financial transaction has occurred. In one or more embodiments, decision 401 comprises detecting, using one or more processors of an electronic device, initiation and completion of an electronic payment transaction. In other embodiments, decision 401 comprises receiving, at a user interface, user input completing an electronic payment transaction. In one or more embodiments, the electronic payment transaction defines an electronic payment transaction recipient and results in the presentation of an electronic payment transaction confirmation on the user interface of the electronic device.

Step 402 then identifies, using one or more processors of the electronic device, one or more electronic payment transaction recipients of the electronic payment transaction or electronic financial transaction. In one or more embodiments, step 402 extracts, using one or more processors, an electronic payment transaction recipient from the electronic payment transaction confirmation.

Step 403 then extracts contextual information associated with the electronic payment transaction from the electronic payment transaction recipient. In one or more embodiments, step 403 comprises extracting a reason the electronic payment transaction was initiated. In one or more embodiments, the extracting occurring at step 403 us performed using artificial intelligence (AI) processing.

Decision 404 determines whether the electronic payment transaction or electronic financial transaction has been completed, thereby resulting in the electronic financial transaction confirmation being presented on the user interface. Decision 405 then determines whether a user captures a screenshot of the electronic payment transaction confirmation. In one or more embodiments, decision 405 comprises receiving, at a user interface, user input requesting a communication device of the electronic device to transmit a screenshot of the electronic payment transaction confirmation to a remote electronic device. In other embodiments, decision 405 comprises detecting a screenshot capture of an electronic payment transaction confirmation presented on a user interface of the electronic device.

Step 406 then extracts an electronic payment transaction recipient from the electronic payment transaction confirmation. Step 406 can further comprise extracting contextual information form the electronic payment transaction confirmation. In one or more embodiments, step 406 correlates, by the one or more processors, the electronic payment transaction recipient with a contacts list accessible by the one or more processors to determine contact information for the electronic payment transaction recipient. In other embodiments, step 406 compares the one or more electronic payment transaction recipients to a contact list available to the one or more processors to obtain one or more instances of contact information corresponding to the one or more processors electronic payment transaction recipients. In one or more embodiments, the contacts list utilized at step 406 is associated with a social media application operable on the one or more processors.

Step 407 determines whether any of the extracted electronic payment transaction recipients have had screenshots of previous electronic payment transaction recipients sent from the electronic device. In one or more embodiments where there is a plurality of electronic payment transaction recipients, step 408 prioritizes the electronic payment transaction recipients by a number of prior electronic payment transaction confirmation screenshot transmissions sent to each electronic payment transaction recipient, as determined at step 407, of the plurality of electronic payment transaction recipients. Thus, is one of the electronic payment transaction recipients receives a screenshot of an electronic payment transaction once a week from the electronic device, while others receive one a year, the once a week electronic payment transaction recipient may be prioritized over others in one or more embodiments.

Step 409 then presents the potential electronic payment transaction recipients on a user interface. In one or more embodiments, step 409 comprises presenting at least one electronic payment transaction recipient found in the contact list on the user interface. When the electronic payment transaction recipient identified by the electronic payment transaction corresponds to multiple instances of contact information in the contacts list, step 409 further comprises presenting, by the one or more processors on the user interface, the multiple instances for selection by a user prior to causing the communication device to transmit the screenshot of the electronic payment transaction confirmation to the remote electronic device at step 410.

In one or more embodiments, step 409 allows for a user selection from the potential electronic payment transaction recipients presented on the user interface. Illustrating by example, step 409 can comprise receiving, by the user interface, user input selecting an electronic payment transaction recipient presented on the user interface.

In one or more embodiments, step 410 causes the communication device to transmit the screenshot of the electronic payment transaction confirmation to a remote electronic device using the contact information obtained at step 406. In one or more embodiments, prior to this transmission, step 410 comprises composing a message to accompany the screenshot of the electronic payment transaction confirmation, and thereafter causing the communication device to transmit the message with the screenshot of the electronic payment transaction confirmation to the remote electronic device using the contact information. In one or more embodiments, the message comprises the contextual information extracted at step 407.

When the electronic payment transaction defines at least one other electronic payment transaction recipient in addition to a first electronic payment transaction recipient, and the correlating occurring at step 406 determines multiple instances of contact information, step 410 causes the communication device to transmit the screenshot of the electronic payment transaction confirmation to multiple remote electronic devices using the multiple instances of contact information. In one or more embodiments, step 410 comprises causing, by the one or more processors, a communication device to transmit the screenshot capture of the electronic payment transaction confirmation to the electronic payment transaction recipient using the contact information corresponding to the electronic payment transaction recipient.

Optional step 411 comprises recording, by the one or more processors, an amount of the electronic payment transaction and the electronic payment transaction recipient in a payment share database stored in a memory of the electronic device. The next time the method 400 proceeds, this payment share database can be used at step 407 to determine whether prior screenshots have been shared with a potential electronic payment transaction recipient.

Now that the methods, electronic devices, and systems have been described, attention will be turned to some use cases in which embodiments of the disclosure will be beneficial.

These use cases are illustrative only, as numerous others will be obvious to those of ordinary skill in the art having the benefit of this disclosure.

Beginning with FIG. 5, as previously described this figure illustrates a user 500 interacting with an electronic device 100 after when executing a financial transaction. The screen of the device displays an electronic payment transaction confirmation from the “Bank of Henry,” detailing the transaction specifics. The account number 96220804 and the payment amount of $87.90 are prominently shown in the electronic payment transaction confirmation 501, along with the recipient's information: Mac, whose phone number is 404-555-5523 and account number is 013457. This clear presentation of transaction details ensures that the user can verify the accuracy of the payment before proceeding.

The electronic payment transaction confirmation 501 is presented after the user 500 delivers user input 503 to the “Pay Now” button, which is configured as a user actuation target 502 presented on the user interface of the electronic device 100. The user input 503 is the final step in completing the transaction. This action is captured as user input 503, which the system recognizes as the initiation of the payment process. The user interface of the electronic device is designed to be intuitive, allowing the user to easily navigate through the payment process with minimal effort.

Once the payment is confirmed, the system's AI-based sharing intent recommendation feature comes into play. The system detects the completion of the transaction and prepares to assist the user in sharing the payment confirmation screenshot. By analyzing the transaction details and correlating them with the user's contact list, the system can suggest the most relevant recipients for the screenshot. This ensures that the payment confirmation reaches the intended recipient.

The intended recipient can vary. Of course, it can be the party identified in the electronic payment transaction confirmation 501, which would be Mac. Advantageously, embodiments of the disclosure facilitate this in a simple, quick, and easy manner.

Turning now to FIG. 6, to send a copy of the electronic financial transaction confirmation to Mac, the user 500 must first capture a screenshot 601 of the electronic payment transaction confirmation (501). This has occurred in FIG. 6, as the user 500 is holding the electronic device 100 after it has just captured a screenshot 601 of the electronic payment transaction confirmation (501) from the “Bank of Henry.”The screenshot prominently displays the transaction details.

At the bottom of the screen, a user actuation target 602 is configured as a “Send?” button. This user actuation target 602 allows the user 500 to share the screenshot 601. In one or more embodiments, the electronic device's AI-based sharing intent recommendation feature is designed to assist the user 500 in this process. By analyzing the transaction details and correlating them with the user's contact list, one or more processors of the electronic device 100 can suggest the most relevant recipients for the screenshot. This ensures that the payment confirmation reaches the intended recipient, such as Mac, without any manual searching or potential errors.

This innovative approach not only streamlines the sharing process but also enhances security and efficiency. By automating the recipient selection and sharing process, the system reduces the risk of sensitive financial information being sent to unintended recipients. The user can confidently complete transactions and share confirmations, knowing that the system will accurately and securely handle the details. This feature is particularly useful in scenarios where the user needs to share payment confirmations with specific contacts, such as administrators or clerks managing financial reconciliations, ensuring that the information reaches the right person without any hassle.

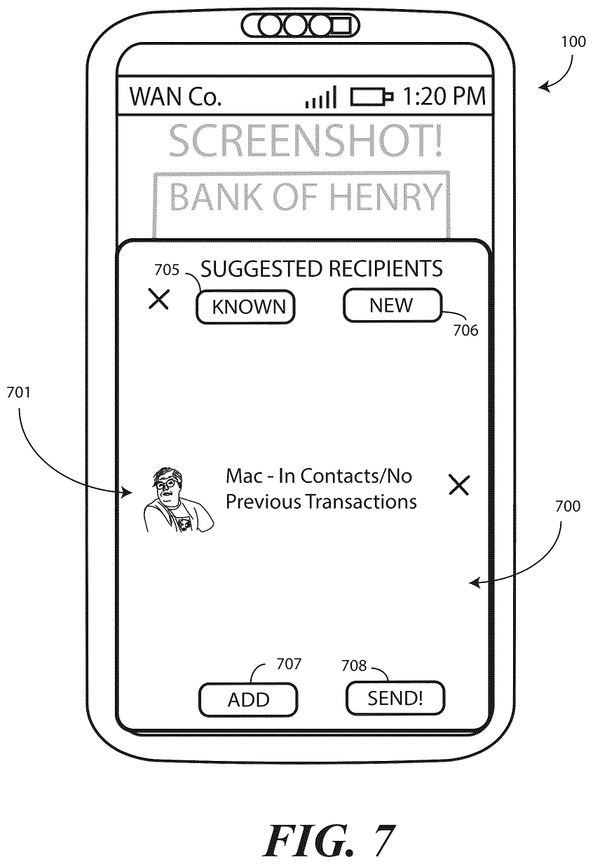

In one or more embodiments, after receiving, at the user interface, other user input requesting a communication device of the electronic device 100 to transmit a screenshot 601 of the electronic payment transaction confirmation (501) to a remote electronic device in FIG. 5, one or more processors of the electronic device 100 extract, from the screenshot 601 of the electronic payment transaction confirmation (501), the electronic payment transaction recipient, which in this case is Mac. In one or more embodiments, the one or more processors correlate the electronic payment transaction recipient with a contacts list accessible by the one or more processors to determine contact information for the electronic payment transaction recipient. In one or more embodiments, the one or more processors then present the electronic payment transaction recipient on the user interface. Turning now to FIG. 7, illustrated therein is one example of this.

As shown in FIG. 7, the one or more processors of the electronic device have extracted an electronic payment transaction recipient 701 from the electronic payment transaction confirmation and have correlated the electronic payment transaction recipient with a contacts list accessible to the one or more processors to determine contact and other information associated with the electronic payment transaction recipient 701. The contact is then presented in a prompt 700. That contact information was correlated is indicated by the fact that the prompt 700 indicates Mac is found “in contacts.” That other information was found is indicated by the fact that the prompt 700 indicates Mac has no previous transactions in which screenshots of electronic payment transaction were forwarded his way.

A user can then deliver user input to a user actuation target 708 marked “send” to simply and easily send the screenshot to Mac. This innovative approach not only streamlines the payment process but also enhances security and efficiency. By automating the recipient selection and sharing process, the system reduces the risk of sensitive financial information being sent to unintended recipients. The user can confidently complete transactions and share confirmations, knowing that the system will accurately and securely handle the details.

However, in the illustrative embodiment of FIG. 7, the user can take other actions as well. Illustrating by example, the user can touch another user actuation target 705 marked “known” to cause the correlation process to repeat, thereby finding other potential electronic payment transaction recipients from the contacts list.

Additionally, embodiments of the disclosure contemplate that the electronic payment transaction recipient may be someone other than that presented. Indeed, the electronic payment transaction recipient may not be found in the contacts list. A user actuation target 706 marked “new” allows the user to manually enter the electronic payment transaction recipient. Additional electronic payment transaction recipients can be added using another user actuation target 707 marked “add.”

Recall from the description of FIG. 2 that rather than extracting the potential electronic payment transaction recipient from the electronic payment transaction confirmation, one or more sensors can identify potential electronic payment transaction recipients by determining who is within the environment of the electronic device 100 when the screenshot of the electronic payment transaction confirmation is captured. Consider, for example, if the electronic payment transaction of FIG. 5 was paying for lunch with the user desiring to be repaid. One or more sensors of the electronic device could detect the users within the vicinity to whom the screenshot of the payment for the meal should be sent.

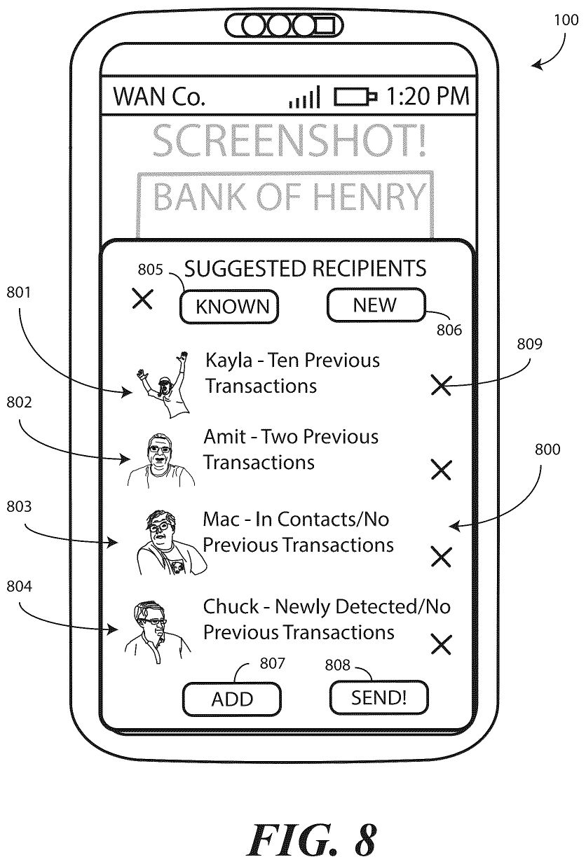

Turning now to FIG. 8, this has occurred. One or more processors of the electronic device 100 have detected initiation and completion of an electronic payment transaction and have identified one or more electronic payment transaction recipients of the electronic payment transaction using one or more sensors, such as image capture devices and audio capture devices, from an environment of the electronic device 100. The one or more processors have also detected a screenshot capture of an electronic payment transaction confirmation presented on a user interface of the electronic device 100.

Moreover, the one or more processors have compared the one or more electronic payment transaction recipients to a contact list available to the one or more processors to obtain one or more instances of contact information corresponding to the one or more electronic payment transaction recipients. The one or more processors have further presented a prompt 800 on the electronic device 100 listing the one or more electronic payment transaction recipients.

In this illustration, since four electronic payment transaction recipients were found, the one or more electronic payment transaction recipients comprises a plurality of electronic payment transaction recipients. Accordingly, they are presented in a list.

In this illustration, the plurality of electronic payment transaction recipients is presented in a list that is prioritized by a number of prior electronic payment transaction confirmation screenshots sent to each electronic payment transaction recipient of the plurality of electronic payment transaction recipients.

Illustrating by example, a first electronic payment transaction recipient 801, Kayla, has had ten previous screenshots sent her way. The next highest electronic payment transaction recipient 802, Amit, has only had two. The lowest prioritized electronic payment transaction recipients 803,804, Mac and Chuck, have had none.

In the prompt 800 of FIG. 8, the user can deliver user input to the user interface to select one or more of the four proposed electronic payment transaction recipients. Additionally, user actuation targets 809 allowing a deselection of the proposed electronic payment transaction recipients is provided as well. The other three user actuation targets 805,806,807 allow adjustments as previously described. User actuation target 808 causes the communication device to transmit the screenshot capture of the electronic payment transaction confirmation using the contact information corresponding to each electronic payment transaction recipient of the plurality of electronic payment transaction recipients.

In still other embodiments, when the one or more processors of the electronic device correlate the electronic payment transaction recipient with a contacts list accessible by the one or more processors to determine contact information for the electronic payment transaction recipient, the contacts list can be associated with a social media application operable on the one or more processors of the electronic device. Consider the situation where the user (500) executing the electronic payment transaction in FIG. 5 had paid for his pinball team to enter a local tournament. Perhaps the user (500) desires to send a screenshot of the electronic payment transaction confirmation (501) to each member of the pinball team. Advantageously, embodiments of the disclosure facilitate this action as well.

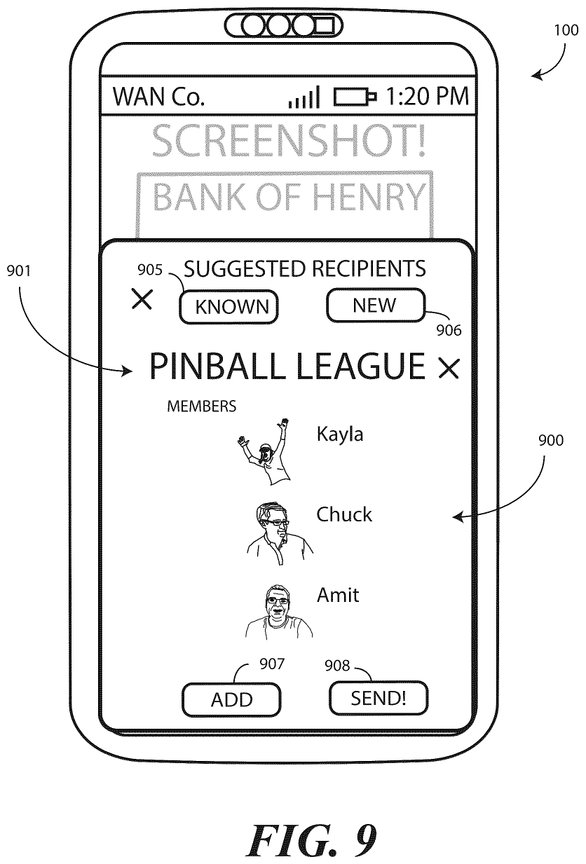

Turning now to FIG. 9, the one or more processors of the electronic device 100 have correlated the electronic payment transaction recipient with a contacts list accessible by the one or more processors to determine contact information for the electronic payment transaction recipients. In the illustration of FIG. 9, the contact information is associated with a social media application operable on the one or more processors. Accordingly, the plurality of electronic payment transaction recipients is associated with the user's pinball league 901, which was found from a social media application. All members of the pinball league 901 are presented in the prompt, as previously described.

The other three user actuation targets 905,906,907 allow adjustments as previously described. User actuation target 908 causes the communication device to transmit the screenshot capture of the electronic payment transaction confirmation using the contact information corresponding to each electronic payment transaction recipient of the plurality of electronic payment transaction recipients.

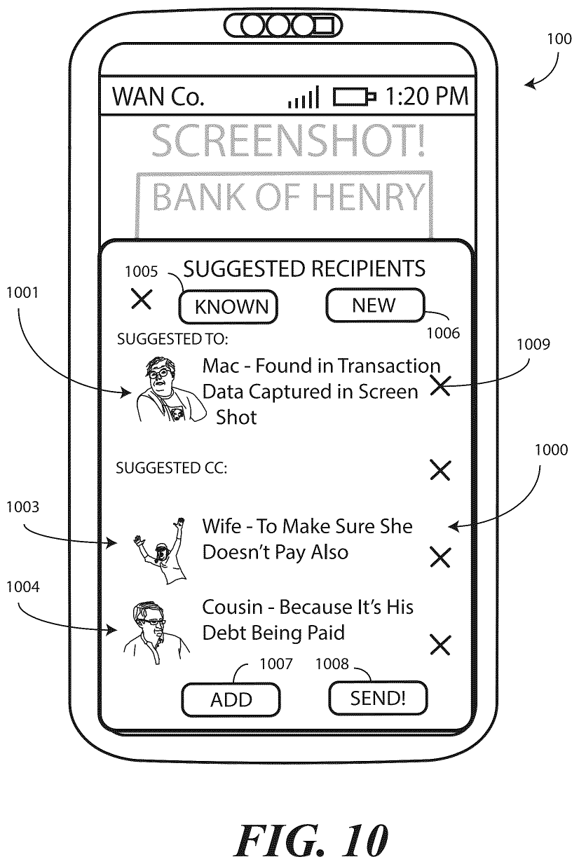

Combinations of the aforementioned techniques can be used as well. Turning now to FIG. 10, the one or more processors have performed the correlation to find multiple electronic payment transaction recipients, which are each presented in the prompt 1000 presented on a user interface of the electronic device.

Consider the situation where Mac is a creditor 1001 to whom the user's cousin 1004 owes money. If the user (500) is making the electronic financial transaction to pay off the cousin's loans, the user (500) may want the creditor 1001 to receive notice of the electronic financial transaction in the form of a screenshot of the electronic payment transaction confirmation so that no harm befalls the cousin 1004. However, the user (500) may want to make sure that his wife 1003 does not also pay the debt payment.

Based upon historical information, routine transactions, past screenshot shares, or other data, the one or more processors can predict this. Illustrating by example, one or more processors of the electronic device 100 can predict electronic payment transaction recipients by analyzing a history of contacts stored in a contact list or social media application to whom previous electronic payment transaction confirmation screenshots have been sent. The processors monitor and record each instance where a screenshot of an electronic payment transaction confirmation is shared with a contact. This historical data is stored in a payment share database within the memory of the electronic device 100. By maintaining a comprehensive log of past transactions and their corresponding recipients, the processors can identify patterns and trends in the user's sharing behavior.

When a new electronic payment transaction is completed, the processors extract the transaction details and compare them against the historical data. The processors can prioritize potential recipients based on the frequency and recency of past transactions. Contacts who have received multiple screenshots in the past can be ranked higher in the list of suggested recipients. This prioritization ensures that the most relevant and likely recipients are presented to the user, streamlining the sharing process and reducing the risk of errors.

Additionally, the processors can leverage artificial intelligence techniques to enhance the accuracy of recipient predictions. By analyzing contextual information such as the transaction amount, merchant details, and the time of the transaction, the processors can correlate these factors with past sharing instances. This correlation allows the system to make more informed predictions about the intended recipient, further improving the efficiency and security of the sharing process. The combination of historical data analysis and AI-driven contextual understanding enables the electronic device to provide highly accurate and relevant recipient suggestions for electronic payment transaction confirmations

In the prompt 1000 shown in FIG. 10, the one or more processors have suggested the creditor 1001 as a suggested recipient but have also suggested the wife 1003 and the cousin 1004 as carbon copy recipients. The one or more processors suggest this because the wife 1003 should not make any payments since the user has, and the cousin 1004 because his debt is being paid. Should these be wrong, a user actuation target 1009 allows deletion of the proposed electronic payment transaction recipient while other user actuation targets 1005,1006,1007 also allow adjustments. If the proposals are correct, user actuation target 1008 allows the electronic payment transaction confirmation to be sent in the form of a screenshot.

In other embodiments, the electronic device 100 is configured to detect the initiation and completion of an electronic payment transaction through a digital wallet application, which monitors transaction events and extracts relevant details such as transaction amount, merchant information, and timestamps. The electronic device 100 identifies electronic payment transaction recipients by analyzing transaction data to extract recipient information, such as names, phone numbers, or email addresses, and compares this information against a contact list stored on the device or accessible through connected services.

In another embodiment, the electronic device 100 employs artificial intelligence (AI) techniques to enhance the accuracy of recipient identification by analyzing contextual information, such as transaction amounts and merchant details, and correlating these factors with past sharing instances. In one or more embodiments, the electronic device 100 detects a screenshot capture of the electronic payment transaction confirmation by monitoring screen activity and recognizing the screenshot action. In one or more embodiments, the electronic device 100 then compares the identified recipients to the contact list to obtain corresponding contact information.

In yet another embodiment, the electronic device 100 presents the identified recipients on the user interface in a prioritized list based on the frequency and recency of past transactions, allowing the user to quickly select the correct recipient. The electronic device 100 can also record the amount of the transaction and the recipient information in a payment share database for future reference, further enhancing the accuracy and convenience of the sharing process. Additionally, the device can be configured to suggest recipients from social media applications, facilitating the sharing of transaction confirmations with groups or communities within those platforms.

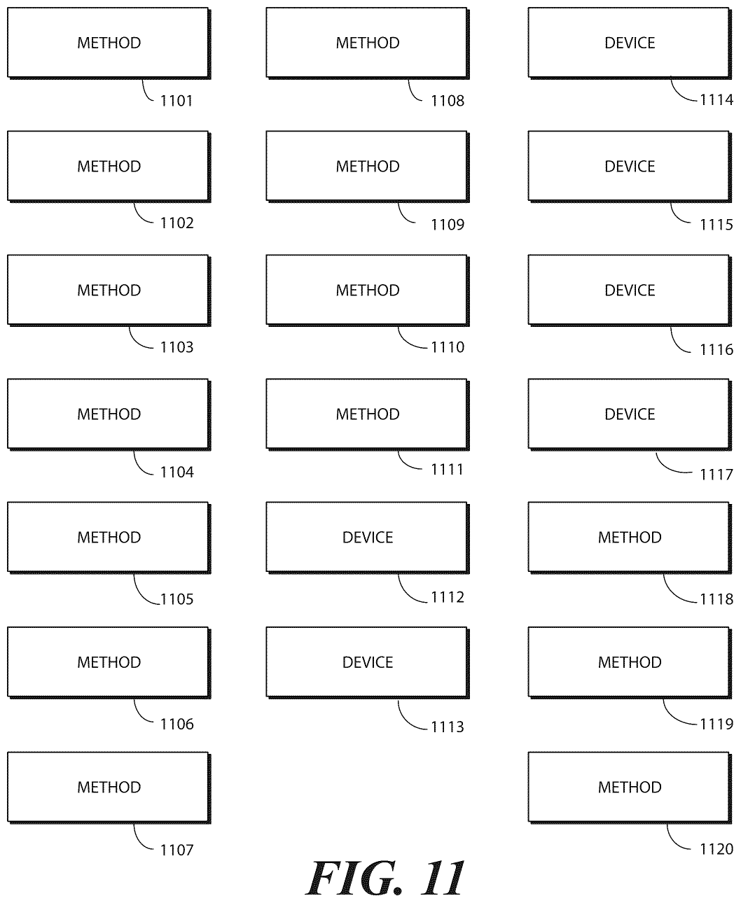

Turning now to FIG. 11, illustrated therein are various embodiments of the disclosure. The embodiments of FIG. 11 are shown as labeled boxes in FIG. 11 due to the fact that the individual components of these embodiments have been illustrated in detail in FIGS. 1-10, which precede FIG. 10. Accordingly, since these items have previously been illustrated and described, their repeated illustration is no longer essential for a proper understanding of these embodiments. Thus, the embodiments are shown as labeled boxes.

At 1101, a method in an electronic device comprises receiving, at a user interface, user input completing an electronic payment transaction defining an electronic payment transaction recipient and resulting in presentation of an electronic payment transaction confirmation by the user interface. At 1101, the method comprises receiving, at the user interface, other user input requesting a communication device of the electronic device to transmit a screenshot of the electronic payment transaction confirmation to a remote electronic device.

At 1101, the method extracts, by one or more processors from the screenshot of the electronic payment transaction confirmation, the electronic payment transaction recipient. At 1101, the method correlates, by the one or more processors, the electronic payment transaction recipient with a contacts list accessible by the one or more processors to determine contact information for the electronic payment transaction recipient. At 1101, the method causes, by the one or more processors, the communication device to transmit the screenshot of the electronic payment transaction confirmation to the remote electronic device using the contact information.

At 1102, the method of 1101 further comprises composing, by the one or more processors, a message to accompany the screenshot of the electronic payment transaction confirmation and causing the communication device to transmit the message with the screenshot of the electronic payment transaction confirmation to the remote electronic device using the contact information. At 1103, the method of 1102 further comprises extracting, by the one or more processors, contextual information associated with the electronic payment transaction, wherein the message comprises the contextual information.

At 1104, the contextual information of 1103 defines a reason the electronic payment transaction was initiated. At 1105, the method of 1102 further comprises recording, by the one or more processors, an amount of the electronic payment transaction and the contact information in a payment share database stored in a memory of the electronic device.

At 1106, when the electronic payment transaction recipient identified by the electronic payment transaction corresponds to multiple instances of contact information in the contacts list, the method of 1101 further comprises presenting, by the one or more processors on the user interface, the multiple instances for selection by a user prior to causing the communication device to transmit the screenshot of the electronic payment transaction confirmation to the remote electronic device. At 1107, the presentation of the multiple instances of contact information on the user interface at 1106 is prioritized.

At 1108, the presentation of the multiple instances of contact information on the user interface at 1107 is prioritized as a function of a number of screenshots of past electronic financial transaction confirmations sent to each instance of contact information. At 1109, the contacts list of 1101 is associated with a social media application operable on the one or more processors. At 1110. the extracting of 1101 is performed using artificial intelligence (AI) processing.

At 1111, the electronic payment transaction of 1101 defines at least one other electronic payment transaction recipient. At 1111, the correlating determines multiple instances of contact information. At 1111, the causing causes the communication device to transmit the screenshot of the electronic payment transaction confirmation to multiple remote electronic devices using the multiple instances of contact information.

At 1112, an electronic device comprises a user interface, a communication device, and one or more processors operable with the user interface and the communication device. At 1112, the one or more processors are configured to determine that an electronic payment transaction has been initiated and completed, identify an electronic payment transaction recipient of the electronic payment transaction using information from a contact database accessible to the one or more processors from contextual information extracted from an electronic payment transaction confirmation, detect a request for the communication device to transmit a screenshot of the electronic payment transaction confirmation, and present one or more potential recipients for the screenshot of the electronic payment transaction confirmation on the user interface.

At 1113, the one or more potential recipients of 1112 comprise a plurality of potential recipients presented in a list on the user interface. At 1114, the list of 1113 is prioritized as a function of previous electronic payment transaction confirmation screenshots delivered to each potential recipient of the plurality of potential recipients. At 1115, the one or more processors of 1114 are further configured to record a user selection made from the list in a payment share database stored in the electronic device.

At 1116, a method in an electronic device comprises detecting, with one or more processors, initiation and completion of an electronic payment transaction. At 1116, the method comprises identifying, with the one or more processors, one or more electronic payment transaction recipients of the electronic payment transaction. At 1116, the method comprises also detecting, with the one or more processors, a screenshot capture of an electronic payment transaction confirmation presented on a user interface of the electronic device. At 1116, the method comprises comparing, with the one or more processors, the one or more electronic payment transaction recipients to a contact list available to the one or more processors to obtain one or more instances of contact information corresponding to the one or more electronic payment transaction recipients. At 1116, the method comprises presenting, by the one or more processors on the user interface, at least one electronic payment transaction recipient found in the contact list on the user interface.

At 1117, the method of 1116 further comprises receiving, by the user interface, user input selecting an electronic payment transaction recipient presented on the user interface. At 1118, the method of 1117 further comprises causing, by the one or more processors, a communication device to transmit the screenshot capture of the electronic payment transaction confirmation to the electronic payment transaction recipient using the contact information corresponding to the electronic payment transaction recipient.

At 1119, the method of 1118 further comprises recording, by the one or more processors, an amount of the electronic payment transaction and the electronic payment transaction recipient in a payment share database stored in a memory of the electronic device. At 1120, the at least one electronic payment transaction recipient of 1116 comprises a plurality of electronic payment transaction recipients presented in a list that is prioritized by a number of prior electronic payment transaction confirmation screenshot transmissions sent to each electronic payment transaction recipient of the plurality of electronic payment transaction recipients.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method in an electronic device, the method comprising:
determining that an electronic payment transaction defining an electronic payment transaction recipient has been completed, thereby resulting in presentation of an electronic payment transaction confirmation by a user interface;
detecting, by one or more processors, a request for a communication device of the electronic device to transmit a screenshot of the electronic payment transaction confirmation to a remote electronic device;
correlating, by the one or more processors, the electronic payment transaction recipient with a contacts list accessible by the one or more processors to determine contact information for the electronic payment transaction recipient; and
causing, by the one or more processors, the communication device to transmit the screenshot of the electronic payment transaction confirmation to the remote electronic device using the contact information.

2. The method of claim 1, further comprising composing, by the one or more processors, a message to accompany the screenshot of the electronic payment transaction confirmation and causing the communication device to transmit the message with the screenshot of the electronic payment transaction confirmation to the remote electronic device using the contact information.

3. The method of claim 2, further comprising extracting, by the one or more processors, contextual information associated with the electronic payment transaction, wherein the message comprises the contextual information.

4. The method of claim 3, wherein the contextual information defines a reason the electronic payment transaction was initiated.

5. The method of claim 2, further comprising recording, by the one or more processors, an amount of the electronic payment transaction and the contact information in payment share database stored in a memory of the electronic device.

6. The method of claim 1, wherein when the electronic payment transaction recipient identified by the electronic payment transaction corresponds to multiple instances of contact information in the contacts list the method further comprises presenting, by the one or more processors on the user interface, the multiple instances for selection by a user prior to causing the communication device to transmit the screenshot of the electronic payment transaction confirmation to the remote electronic device.

7. The method of claim 6, wherein presentation of the multiple instances of contact information on the user interface is prioritized.

8. The method of claim 7, wherein the presentation of the multiple instances of contact information on the user interface is prioritized as a function of a number of screenshots of past electronic financial transaction confirmations sent to each instance of contact information.

9. The method of claim 1, wherein the contacts list is associated with a social media application operable on the one or more processors.

10. The method of claim 1, wherein the correlating extracting is performed using artificial intelligence (AI) processing.

11. The method of claim 1, wherein:
the electronic payment transaction defines at least one other electronic payment transaction recipient;
the correlating determines multiple instances of contact information; and
the causing causes the communication device to transmit the screenshot of the electronic payment transaction confirmation to multiple remote electronic devices using the multiple instances of contact information.

12. An electronic device, comprising:
a user interface;
a communication device; and
one or more processors operable with the user interface and the communication device;
wherein the one or more processors are configured to determine that an electronic payment transaction has been initiated and completed, identify an electronic payment transaction recipient of the electronic payment transaction using information from a contact database accessible to the one or more processors from contextual information extracted from an electronic payment transaction confirmation, detect a request for the communication device to transmit a screenshot of the electronic payment transaction confirmation, and present one or more potential recipients for the screenshot of the electronic payment transaction confirmation on the user interface.

13. The electronic device of claim 12, wherein the one or more potential recipients comprise a plurality of potential recipients presented in a list on the user interface.

14. The electronic device of claim 13, wherein the list is prioritized as a function of previous electronic payment transaction confirmation screenshots delivered to each potential recipient of the plurality of potential recipients.

15. The electronic device of claim 14, wherein the one or more processors are further configured to record a user selection made from the list in a payment share database stored in the electronic device.

16. A method in an electronic device, the method comprising:
detecting, with one or more processors, initiation and completion of an electronic payment transaction;
identifying, with the one or more processors, one or more electronic payment transaction recipients of the electronic payment transaction;
also detecting, with the one or more processors, a screenshot capture of an electronic payment transaction confirmation presented on a user interface of the electronic device;
comparing, with the one or more processors, the one or more electronic payment transaction recipients to a contact list available to the one or more processors to obtain one or more instances of contact information corresponding to the one or more electronic payment transaction recipients; and
presenting, by the one or more processors on the user interface, at least one electronic payment transaction recipient found in the contact list on the user interface.

17. The method of claim 16, further comprising receiving, by the user interface, user input selecting an electronic payment transaction recipient presented on the user interface.

18. The method of claim 17, further comprising causing, by the one or more processors, a communication device to transmit the screenshot capture of the electronic payment transaction confirmation to the electronic payment transaction recipient using the contact information corresponding to the electronic payment transaction recipient.

19. The method of claim 18, further comprising recording, by the one or more processors, an amount of the electronic payment transaction and the electronic payment transaction recipient in a payment share database stored in a memory of the electronic device.

20. The method of claim 16, wherein the at least one electronic payment transaction recipient comprises a plurality of electronic payment transaction recipients presented in a list that is prioritized by a number of prior electronic payment transaction confirmation screenshot transmissions sent to each electronic payment transaction recipient of the plurality of electronic payment transaction recipients.
